(19) United States
(12) Patent Application Publication
(10) Pub. No.: US 2006/0154224 A1
(43) Pub. Date: Jul. 13, 2006

(54) Iron buck antler mount

(76) Inventor: Darrin Blake St.Ama, Early, TX (US)

Correspondence Address: Darrin B. St.Ama, 500 Early Blvd., Early, TX, 76802, US

(21) Appl. No.: 11/320,446

(22) Filed: Dec. 27, 2005

Related U.S. Application Data
(60) Provisional application No. 60/642,582, filed on Jan. 11, 2005.

(51) Int. Cl. G09B 23/00

(52) U.S. Cl. 434/296

(57) ABSTRACT

This invention relates directly to the display of deer antlers, as a sculpture, replicating the look of a “European” style mount—a natural, boiled and bleached skull. This invention resembles that of a natural buck's skull—complete with all those characteristics of a skull in its natural state. The mount consists of two steel plates. The outermost plate in the shape and possessing characteristics of a deer skull, the back plate, flat, having slots and protrusions to enable the user to hang on the wall or bracket in a three-dimensional manner. This invention is for the sole purpose of decoration and display of a deer's antlers.

### CROSS-REFERENCE TO RELATED APPLICATIONS

This application claims the benefit of provisional patent application Ser. No. 60/642,582, filed 2005 Jan. 11 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to trophy mount for displaying antlers or horns in a “European” style, 3-dimensional fashion.

2. Prior Art

Many animals, whether domesticated or wild, have horns, antlers, or the like, which can be attractive when mounted for display. Particularly attractive is the rack (antler, horns or the like) taken from a game animal by a hunter. The most common method of mounting such a rack is to employ a taxidermist to mount the rack in a life-like manner, but this method involves long delays in mounting the rack and is often expensive. Alternatively, trophy mounts have been proposed whenever the rack is attached to a plaque covered in a cloth material like felt, leather, vinyl or other sheet material.

Patents illustrating this type of trophy mount is U.S. Pat. No. 3,319,922. Another method of display is referred to as a “European Mount.” This method consists of leaving the rack attached to the original skull and boiling the skull and cleaning it. This leaves you with a bleached out skull in a very natural state. Although less time consuming and expensive, it still remains an art which is better left to the professionals. Alternatively, the use of wall mounting kits is known in the prior art. More specifically, wall mounting kits devised and utilized for mounting antler of various animals are known to consist basically of familiar, expected and obvious structural configurations, notwithstanding the myriad of designs encompassed by the crowded art which have been developed for the fulfillment of countless objectives and requirements.

U.S. Pat. No. 453,008 (1891) Kaemper; U.S. Pat. No. 2,003,896 (1935) Menger; U.S. Pat. No. 5,472,765 (1995) Green; U.S. Pat. No. 4,464,440 (1984) Dotzman, U.S. Pat. No. 3,319,922, (1967) Christensen U.S. Pat. No. 4,717,626 (1988) Badger

Although prior art has revealed several types of trophy mounts, they consistently oversimplify the design and often the final result is dependent on how well you follow the instructions provided. Many times the unskilled consumer is disappointed with the end result that is often not aesthetically pleasing. Likewise, the finished product rarely simulates the natural lines of the original skull.

### OBJECTS AND ADVANTAGES

Accordingly, besides the objects and advantages of trophy mount described in the above patent, several objects and advantages of the present invention are:

(a) To provide an antler mount that truly resembles the natural skull of the animal from which they were harvested;

(b) To provide an antler mount that is simple to use;

(c) To provide an antler mount that is durable and can be used over and over with antlers of the same species;

(d) To prove an antler mount that aside from displaying antlers, has a sculpture-like quality;

(e) To provide an antler mount that can be painted any color and easily cleaned;

(f) To provide an antler mount that accepts both, antlers attached to the skull plate and collected sheds.

Further, objects and advantages are to provide an antler mount that enables the user to slide the antlers into the antler mount and be finished with the tightening of a bolt. Further objects and advantages will become apparent from a consideration of the ensuing description and drawings.

### SUMMARY

In accordance with the present invention the antler mount comprises two plates; one plate resembling the topside of the natural skull, and the other being flat. The two plates being pulled together by the tightening of a bolt, clamping the antlers between the two plates. Other parts can be the skull block, for use with sheds and possibly a wall/table display bracket.

### DRAWINGS—FIGURES

In the drawings, closely related figures have the same number but different alphabetic suffixes.

FIG. 1 is a front view showing a pair of deer horns (10) mounted in accordance with the invention.

FIG. 2 is a view of the face plate showing pertinent slots and cutouts for application.

FIG. 3 is a view of the back plate 2 showing pertinent slots and cutouts for application.

FIG. 4 is a side view, showing the engaging components required to fabricate a finished antler mount less the antlers.

FIG. 5 is a side elevation view, showing the antler mount in use, with wall/table bracket. (optional)

FIG. 6 is a view of the wall/table bracket. (optional)

### DESCRIPTION OF THE PREFERRED EMBODIMENT

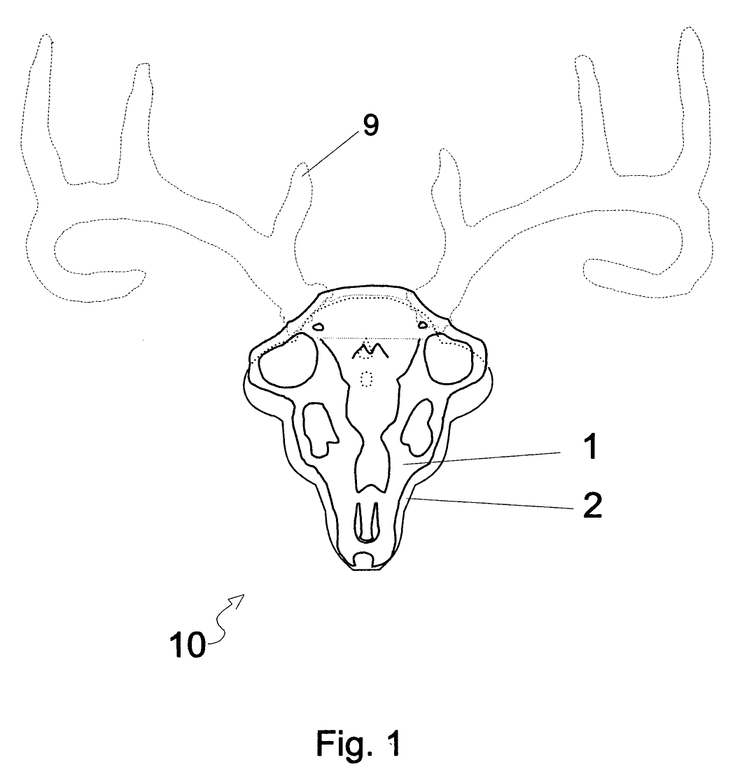

With reference now to the drawings, and in particular to FIG. 1 thereof, a new antler mounting kit embodying the principles and concepts of the present invention and generally designated by the reference numeral 10 will be described.

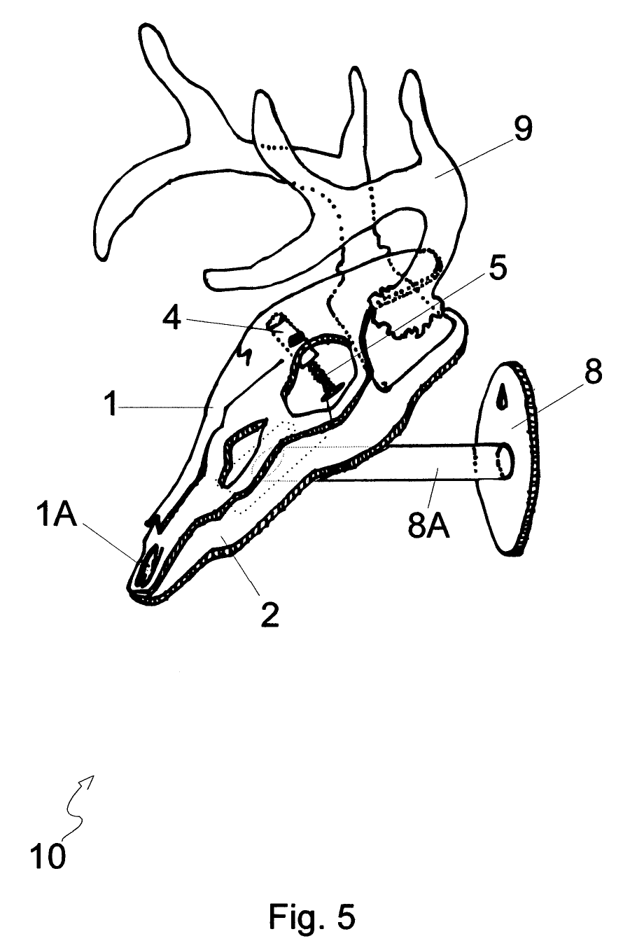

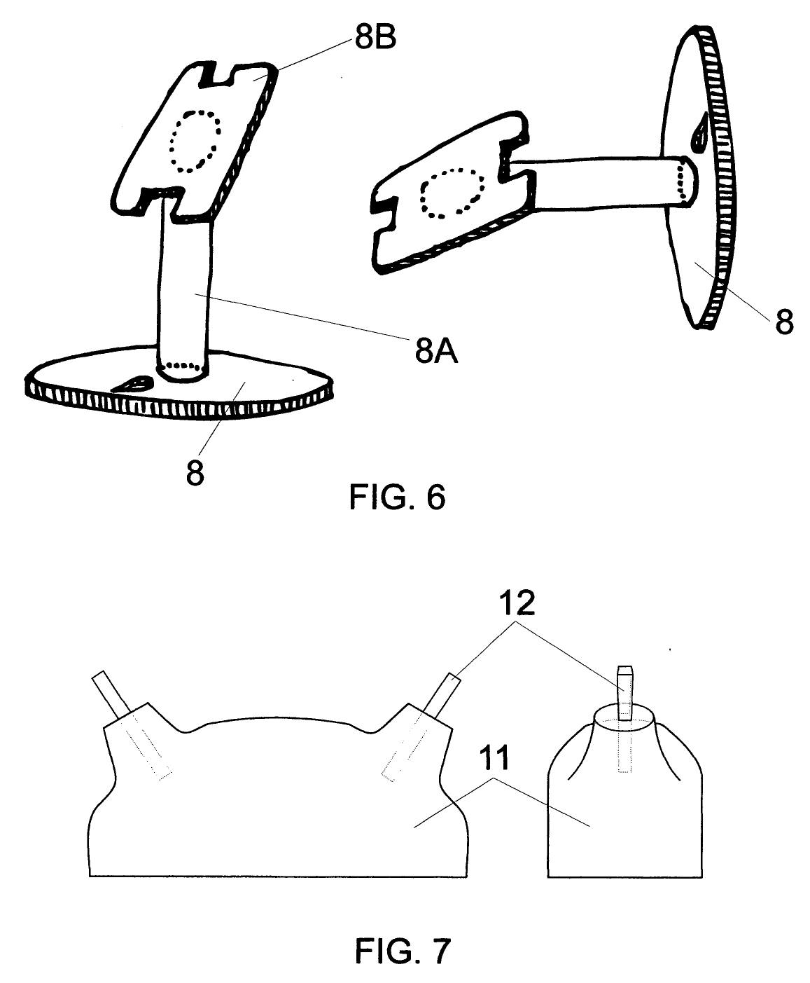

From an overview standpoint, the antler mount 10 is adapted and designed for use with a wall/table bracket disposed thereon (SEE FIG. 5 AND FIG. 6). The Antler Mount 10 comprises an animal skull replical, a base plate 2, a wall/table bracket 8, and a set of antlers 9. The Antler Mount 10 is devised to provide an aesthetically pleasing wall or table mount for antlers 9 wherein the skull replica 1 impart more of a realistic skull, presenting detailed features of animal skull specifically the skull type of a Whitetail or Mule deer. The dimensions shown fit a large average of Whitetail deer, but can be altered to fit a larger number of species depending on dimensions between antler bases.

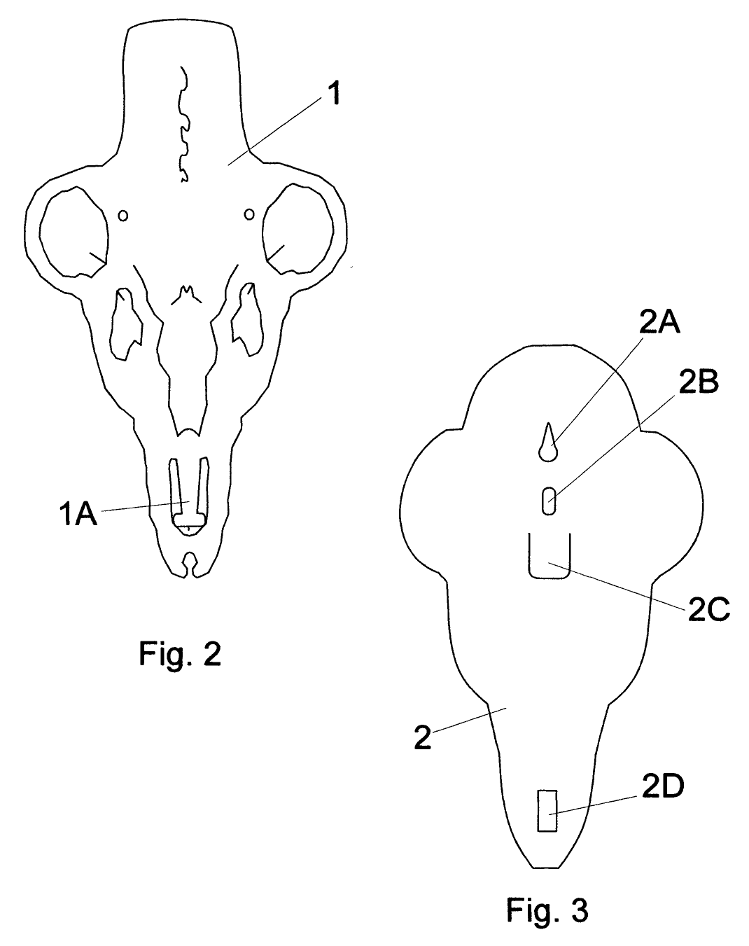

A method of preparing the antler mount and its components is cutting or stamping the patterns FIG. 2 and FIG. 3 from a suitable sheet iron material consisting of, but not limited to mild steel, copper, aluminum or even cast-in steel, resin, or polymeric solid.

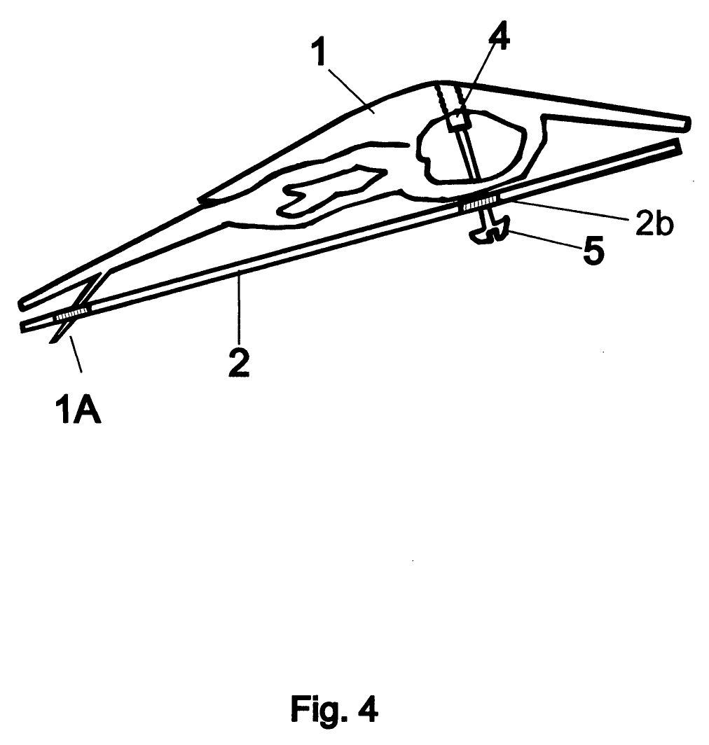

Face plate 1 of said antler mount is pressed or formed in way to appear realistic. Allowing the eyes and forehead to appear rounded. Threaded coupler 4 is then affixed by welding or other suitable process in appropriate location on backside of Face plate FIG. 4. Pivot tab 1A is then placed in slot 2D. This becomes the p0ivot/hinge point, allowing user to place antlers in appropriate location behind the eye slots. Place corresponding bolt through slot 2B until it connects to coupler 4. Tighten said bolt until antlers are secure.

The antler mount can now be mounted to the wall using slot 2A in FIG. 3 or by attaching antler mount 10 to the wall/table bracket by sliding tab 2C, FIG. 3 over Plate 8B, FIG. 6.

If using said antler mount for shed antlers, place optional shed attachment block in appropriate location; tighten bolt 5 into coupler 4 until it becomes secure. Drill hole of equivalent diameter of mounting pin 12 into base of shed antler. Apply adhesive to mounting pin 12 and slide shed antler onto said mounting pin, adjusting shed antler accordingly.

Shed attachment block 11 comprises a substantially polymeric solid which may have a painted surface to match finish on antler mount. Said block has mounting pins protruding at angles reflective of antlers protruding actual skull of actual animal.

As to the manner of usage and operation of the present invention, the same should be apparent from the above description. Accordingly, no further discussion relating to the manner of usage and operation will be provided.

With respect to the above description then it is to be realized that he optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

In as much as the present disclosure includes that contained in the appended claims as well as that of the foregoing description. Although this invention has been described in its preferred forms with a certain degree of particularity, it is understood that the present disclosure of the preferred form has been made only by way of example and numerous changes in the details of construction and combination and arrangement of parts may be resorted to without departing from the spirit and scope of the invention.

What is claimed as being new and desired to be protected by Letters Patent of the United States is as follows:

1. A new and improved antler mount used for both antlers and skull plate attached or for use with collected shed antlers comprising:
a replicated deer skull which hinges or pivots at one pint and is drawn together in a clamping motion to secure skull plate to create a quick, reusable antler mount with rugged good looks replicating that of a “European” mount. Accordingly, the reader will see that the Iron Buck Antler Mount can be used to display both shed antlers and antlers with affixed skull plate, easily and conveniently, can be reused over and over with different antlers of similar Species, specifically Whitetail and Mule deer species.
   Additional advantages are that:
1 It permits mass production of said design to make readily available and cost-effective;
2 It permits user to quickly place antlers in antler mount and display in a matter of minutes without prior knowledge of invention;
3 It permits user to reuse over and over as the hunter or sportsman acquires larger or better antlers or sheds;
4 It permits the user to mount either skull plate or shed antlers in the same application;
5 It permits user to display antlers in a way that is aesthetically pleasing, with a sculpture-like appearance;
6 It provides an antler mount that can be displayed on wall or table, quickly and easily.

I claim:

1. A trophy mount for displaying a set of antlers, either still attached to skull plate or collected shed antlers.

2. A trophy mount resembling that of an actual animal skull, complete with eye sockets, nasal passages, and fractures that exist in that of a real skull.

3. A trophy mount that can be used quickly and easily, over and over by merely clamping the antler skull plate between two steel plates by means of tightening a hidden bolt.

4. Face plate hinges or pivots off back plate creating simple clamp-like system where skull plate slides into respective space creating attractive sculpture-like appearance.
